(19) United States
(12) Patent Application Publication
(10) Pub. No.: US 2010/0156643 A1
(43) Pub. Date: Jun. 24, 2010

(54) Stimulus Delivery Device Having an Adjustable Stimulus Intensity Range

(76) Inventors: Greg Gillis, Escondido, CA (US); Brent A. Goetzl, Orinda, CA (US); Lance Tracy, Oak Ridge, TN (US); James L. Jameson, Seymour, TN (US); Chris Morgan, Knoxville, TN (US)

Correspondence Address: PITTS AND BRITTIAN P C, P O BOX 51295, KNOXVILLE, TN, 37950-1295, US

(21) Appl. No.: 12/637,848

(22) Filed: Dec. 15, 2009

Related U.S. Application Data
(60) Provisional application No. 61/122,627, filed on Dec. 15, 2008.

(51) Int. Cl. G08B 23/00; A01K 15/02

(52) U.S. Cl. 340/573.3; 119/720

(57) ABSTRACT

Described is an animal training system for delivering a stimulus to an animal, whereby the intensity of the stimulus is selected from a plurality of intensities that is within a selectable range of available intensities. More specifically, each of the plurality of intensities is within the range of available intensities. The range of available intensities is selected or defined by a user such that the lower limit and the upper limit of the selected range of available intensities defines the lower limit for minimum intensity and the upper limit for the maximum intensity of the plurality of intensities, respectively. Accordingly, each of the plurality of intensities is defined by the selected range of available intensities.

### CROSS-REFERENCE TO RELATED APPLICATIONS

This application claims the benefit of U.S. Provisional Patent Application No. 61/122,627, filed on Dec. 15, 2008.

### STATEMENT REGARDING FEDERALLY SPONSORED RESEARCH OR DEVELOPMENT

Not Applicable

### BACKGROUND OF THE INVENTION

1. Field of the Invention

This invention pertains to an animal training device for delivering a stimulus to an animal.

2. Description of the Related Art

Many animal training systems include a stimulus delivery device that delivers a stimulus to an animal to correct or reward the animal for an exhibited behavior. The sensitivity of an animal to a stimulus of a particular intensity is dependent on the particular animal and can vary greatly among seemingly similar animals. This variance in sensitivity among animals can be attributed to the animal's size, age, species, breed, skin type, disposition, or general condition. When the intensity of the stimulus does not properly suit the receiving animal, the animal may be irresponsive to the stimulus or, worse, the stimulus may cause the animal to become distressed. For example, when the intensity of the stimulus is too low, it may not be sufficient to capture the animal's attention such that the animal does not alter its behavior in response to receiving the stimulus. On the other hand, when the intensity is too high, it may cause the animal distress to the extent that the animal is unmanageable.

In an effort to resolve the above-described issue, conventional animal training systems include a stimulus delivery device that is able to deliver stimuli of varying intensities to accommodate various animals. Typically, these stimulus delivery devices are in communication with a transmitter operated by a user. Typically, the transmitter includes a plurality of switches, such as push buttons, whereby each switch corresponds with a predefined stimulus intensity. When the user operates one of the plurality of switches, the stimulus delivery device delivers a stimulus having the corresponding intensity. These conventional devices are limited in that only one, or a least a limited number, of the provided intensities may actually be suitable for use with a particular animal. For example, the lowest provided intensity may be suitable for a given animal, whereas the highest provided intensity may cause the same animal distress. As another example, the highest provided intensity may be suitable for a given animal, whereas the lowest provided intensity may not affect the same animal's behavior. When only one, or a limited number, of the provided intensities are suitable for use, the available animal training schemes are limited. For example, many animal training schemes include delivering stimuli of increasing intensity in response to increasingly extreme behavior and delivering stimuli of varying intensities in conditioning an animal. Consequently, a device that provides stimuli of various intensities within an adjustable range is desired.

### BRIEF SUMMARY OF THE INVENTION

In accordance with the various features of the present invention there is provided an animal training system for delivering a stimulus to an animal, whereby the intensity of the stimulus is selected from a plurality of intensities that is within a selectable range of available intensities. More specifically, the animal training system includes a transmitter device and a stimulus delivery device. A user selects the range of available intensities using, in one embodiment, the transmitter device and, in another embodiment, the stimulus delivery device. One of the plurality of intensities is selected at the transmitter device, either manually by the user or by an automated feature. Each of the plurality of intensities is within the selected range of available intensities such that each of the plurality of intensities is defined by the range of available intensities. Upon the operation of the transmitter device by the user or the detection of a behavior exhibited by the animal, the transmitter device transmits an activation signal that is indicative of the selected one of the plurality of intensities. The stimulus delivery device is carried by the animal, receives the activation signal, and delivers a stimulus to the animal, whereby the stimulus has the selected one of the plurality of intensities.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram illustrating one embodiment of the animal training system in accordance with the various features of the present invention;

FIG. 2 is a chart illustrating one embodiment of the relationship between the range of available intensities and the plurality of intensities; and

FIG. 3 is a chart illustrating the relationship of FIG. 2 in greater specificity.

### DETAILED DESCRIPTION OF THE INVENTION

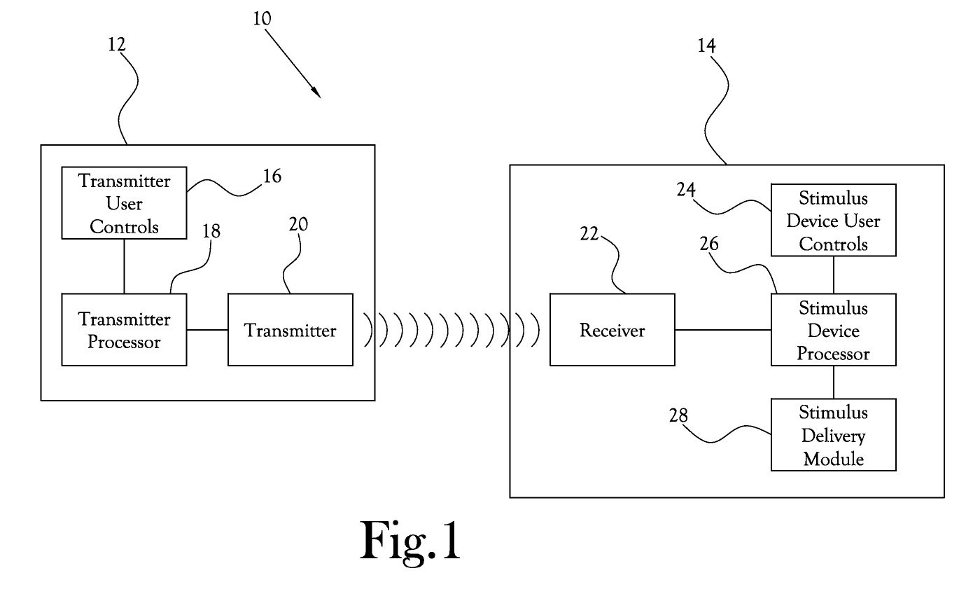

The present invention provides an animal training system for delivering a stimulus to an animal, whereby the intensity of the stimulus is selected from a plurality of intensities that is within a selectable range of available intensities. More specifically, each of the plurality of intensities is within the range of available intensities. The range of available intensities is selected or defined by a user such that the lower limit and the upper limit of the selected range of available intensities defines the lower limit for the minimum intensity and the upper limit for the maximum intensity of the plurality of intensities, respectively. Accordingly, each of the plurality of intensities is defined by the selected range of available intensities. The training system enables a user, or an automated feature, to select one of the plurality of intensities, the selected intensity defining the intensity of the stimulus delivered to the animal. Consequently, the system enables the user to select the range of available intensities such that each of the plurality of intensities is suitable to be delivered to the animal in view of the animal's particular sensitivities to the stimulus. A block diagram of one embodiment of the animal training system constructed in accordance with the various features of the present invention is illustrated generally at 10 in FIG. 1.

The animal training system of FIG. 1 includes a transmitter device 12 and a stimulus delivery device 14. The transmitter device 12 is in wireless communication with the stimulus delivery device 14, and the stimulus delivery device 14 is adapted to be carried by the animal. In the illustrated embodiment, the transmitter device 12 includes transmitter user controls 16, a transmitter processor 18, and a transmitter 20. The transmitter processor 18 is in electrical communication with the transmitter user controls 16 and the transmitter 20. Also, in the illustrated embodiment, the stimulus delivery device 14 includes a receiver 22, stimulus device user controls 24, a stimulus device processor 26, and a stimulus delivery module 28. The stimulus device processor 26 is in electrical communication with the receiver 22, the stimulus device user controls 24, and stimulus delivery module 28.

The system 10 enables a user to select a range of available intensities. Selecting the range of available intensities includes selecting a range from a plurality of discrete ranges, each of the plurality of discrete ranges being either predefined or defined by the user. Selecting the range of available intensities also includes defining the range by defining the lower limit and the upper limit of the range. A plurality of intensities is defined within the selected range of available intensities such that the lower limit and the upper limit of the range define the lower limit for the minimum intensity and the upper limit for the maximum intensity of the plurality of intensities, respectively. The plurality of intensities includes two or more discrete intensities that are distributed within the range of available intensities in any manner. For example, in one embodiment, the intensities are distributed evenly within the range of available intensities such that the increase in intensity among the plurality of intensities is linear.

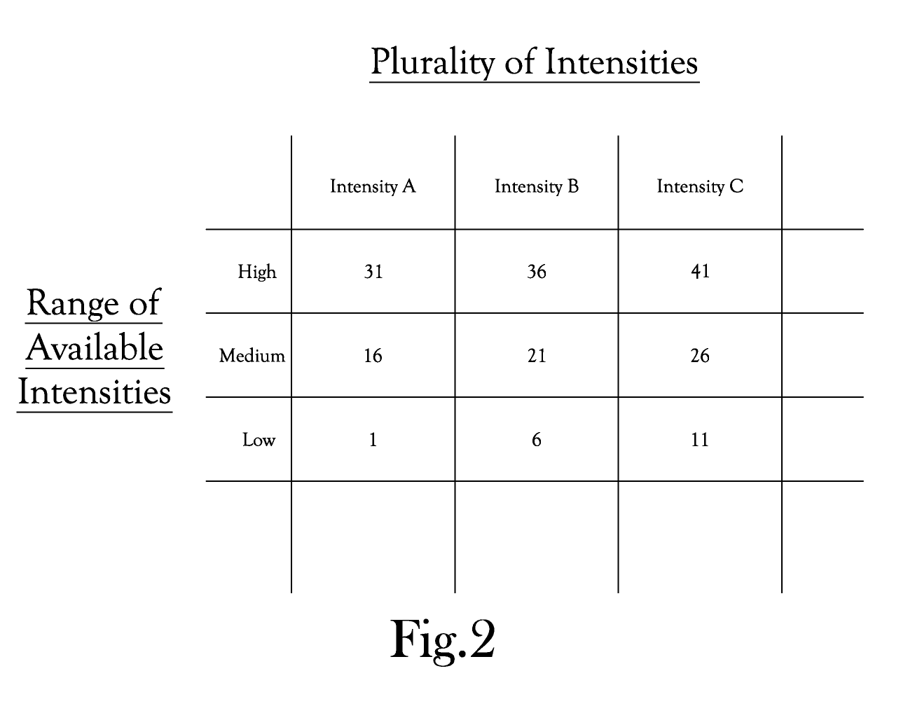

In accordance with the above discussion, each of the plurality of intensities is defined by the selected range of available intensities. To better illustrate the relationship between the plurality of intensities and the range of available intensities, consider the exemplary embodiment, illustrated at FIG. 2, where the plurality of intensities includes Intensity A, Intensity B, and Intensity C and where the ranges of available intensities include a High Range, a Medium Range, and a Low Range. Also, in the illustrated embodiment, the Low Range includes intensities quantized to have values 1-11, the Medium Range includes intensities quantized to have value 16-26, and the High Range includes intensities quantized to have values 31-41. Additionally, the plurality of intensities is distributed evenly within the selected range of available intensities such that the minimum of the plurality of intensities is at the lower limit of the range and the maximum of the plurality of intensities is at the upper limit of the range. Accordingly, when the Low Range is selected, Intensity A is defined as having a value of 1, Intensity B is defined as having a value of 6, and Intensity C is defined as having a value of 11. Likewise, when the Medium Range is selected, Intensity A is defined as having a value of 16, Intensity B is defined as having a value of 21, and Intensity C is defined as having a value of 26. And, when the High Range is selected, Intensity A is defined as having a value of 31, Intensity B is defined as having a value of 36, and Intensity C is defined as having a value of 41. Considering the relationship between the range of available intensities and the plurality of intensities, the intensity value that defines each of the plurality of intensities is not fixed but is dependent on the selected range of available intensities.

As discussed above, the system 10 enables the user to select the desired range of available intensities. The range of available intensities is typically selected such that each of the plurality of intensities is suitable for use in training the animal, as will be further discussed subsequently. In one embodiment, the range of available intensities is selected using the transmitter user controls 16 of the transmitter device 12. In another embodiment, the range of available intensities is selected using the stimulus device user controls 24 of the stimulus delivery device 14. For example, in one embodiment, the stimulus device user controls 24 consist of an ON/OFF button, whereby the user selects the range of available intensities using the ON/OFF button. More specifically, the user activates the stimulus delivery device 14 by pressing and releasing the ON/OFF button. Immediately thereafter, the user presses and holds the ON/OFF button to invoke the function for selecting the range of available intensities. The currently selected range of available intensities is indicated by, for example, a blinking LED and/or an audible tone. While the ON/OFF button is held at the pressed position, the stimulus device processor 26 cycles through the available ranges. When the desired range of available intensities is indicated, the user releases the ON/OFF button, selecting the currently indicated range. It should be noted that the stimulus device user controls 24 can include controls other than an ON/OFF button and that the user can select the range of available intensities by ways other than that discussed above without departing from the scope or spirit of the present invention. For the purposes of the following discussion of the operation of the system 10, the embodiment of the system 10 where the user selects the range of available intensities using the stimulus device user controls 24 is considered.

One of the plurality of intensities is selected using the transmitter device 12. In one embodiment, the user manually selects the selected one of the plurality of intensities. In another embodiment, the selected one of the plurality of intensities is selected automatically by the transmitter device 12 based on the detection of the occurrence of a predetermined event. For example, in one embodiment, the transmitter device 12 detects the distance of the stimulus delivery device 14, and thus the distance of the animal, from the transmitter device 12. Considering the embodiment of FIG. 2, when the transmitter device 14 detects that the animal is a first distance from the transmitter device 14, it selects Intensity A. Likewise, when the transmitter device 14 detects that the animal is a second distance from the transmitter device 14, the second distance being greater than the first, it selects Intensity B. And, when the transmitter device 14 detects that the animal is a third distance from the transmitter device 14, the third distance being greater than the second, it selects Intensity C. For the purposes of the following discussion of the operation of the system 10, the embodiment of the system 10 where the user manually selects the selected one of the plurality of intensities using the transmitter user controls 16 is considered.

Considering the above-discussed exemplary embodiment, the user selects the range of available intensities using the stimulus device user controls 24 of the stimulus delivery device 14. The selected range of available intensities is received by the stimulus device processor 26. After the user selects the range of available intensities, the user selects one of the plurality of intensities using the transmitter user controls 16. The selected one of the plurality of intensities is received by the transmitter processor 18. When the user wishes to deliver the stimulus to the animal, the user activates the transmitter device 12 using the transmitter user controls 16. The transmitter processor 18 receives the activation instructions and wirelessly transmits an activation signal, which is indicative of the selected one of the plurality of intensities, by way of the transmitter 20. The activation signal is received by the receiver 22 of the stimulus delivery device 14 and is ultimately received by the stimulus device processor 26. The stimulus device processor 26 considers the selected range of available intensities and the selected one of the plurality of intensities and activates the stimulus delivery module 28 to deliver a stimulus to the animal, whereby the stimulus delivered to the animal has an intensity defined by the selected range of available intensities and the selected one of the plurality of intensities. For example, considering the embodiment of FIG. 2, when the user selects the High range to be the selected range of available intensities and selects Intensity B to be the selected one of the plurality of intensities, the stimulus device processor 26 activates the stimulus delivery module 28 to deliver a stimulus having an intensity having a value of 36.

As discussed above, the range of available intensities is selected such that each intensity within the range, that is each of the plurality of intensities, is suitable for use in training the animal carrying the stimulus delivery device 14. More specifically, when the intensity of the delivered stimulus does not properly suit the animal, the animal may not be responsive to the stimulus or the stimulus may cause the animal distress. For example, when the intensity of the stimulus is too low, it may not be sufficient to capture the animal's attention when the animal is exhibiting undesired behavior. In circumstances such as these, the animal does not alter its behavior in response to receiving the stimulus. On the other hand, when the intensity is too high, it may cause the animal distress to the extent that the animal becomes unmanageable. The variance in sensitivity among animals can be attributed to the animal's size, age, species, breed, skin type, disposition, or general condition. Regardless of the reason for the variance in sensitivity among animals, the intensity of the stimulus delivered by the system 10 must be suitable for the animal carrying the stimulus delivery device 14. Consequently, the range of available intensities is selected such that each of the plurality of intensities is suitable for the stimulus delivered to the animal. This enables the system 10 to implement a training program that utilizes stimuli of various intensities.

For example, in one embodiment, the transmitter user controls 16 include a plurality of manual controls, such as push button switches, whereby each of the plurality of manual controls corresponds to a respective one of the plurality of intensities. Along these lines, considering the embodiment of FIG. 2, one embodiment of the transmitter user controls 16 includes three manual controls, a first manual control corresponding to Intensity A, a second manual control corresponding to Intensity B, and a third manual control corresponding to Intensity C. After the user selects the range of available intensities, the user operates one of the plurality of manual controls to deliver a stimulus to the animal. More specifically, when the user operates the first manual control, the stimulus delivery module 28 is activated to deliver a stimulus having Intensity A to the animal. Likewise, when the user operates the second manual control, the stimulus delivery module 28 is activated to deliver a stimulus having Intensity B to the animal. And, when the user operates the third manual control, the stimulus delivery module 28 is activated to deliver a stimulus having Intensity C to the animal. Because each of the plurality of intensities is suitable for use with the animal, the user is able to operate any of the plurality of manual controls with confidence that the stimulus will impact the animal's behavior and without concern that the stimulus will cause the animal unnecessary distress. It should be noted that configurations of the transmitter user controls 16 can vary from the above-described embodiment of the user controls without departing from the scope or spirit of the present invention.

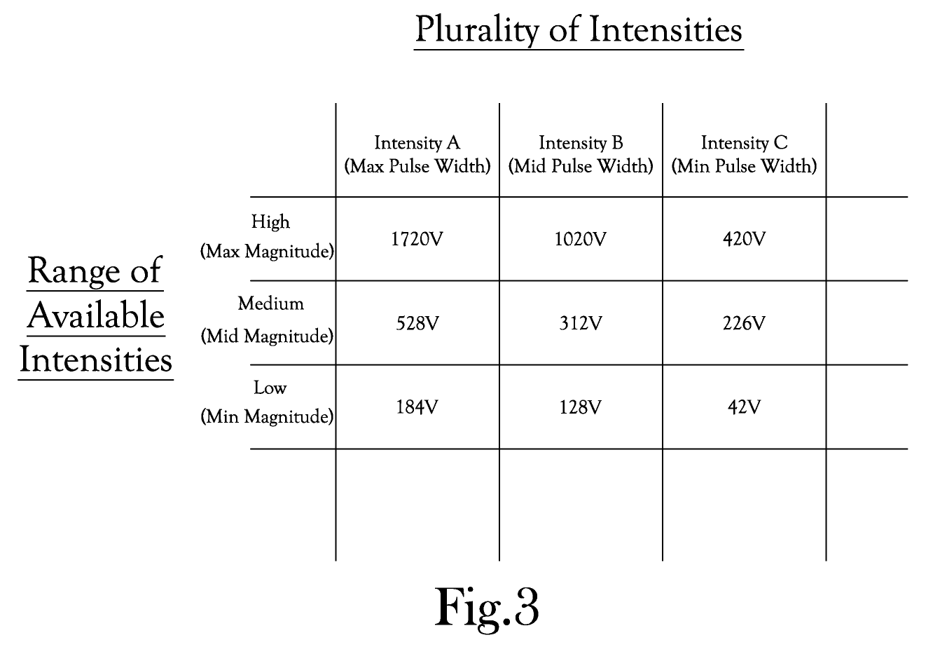

In one embodiment, the stimulus delivered to the animal is an electrical stimulus. Such a stimulus is generated by applying electrical current to certain electrical components of the stimulus delivery module 28, thus electrically energizing the components. The stimulus is delivered by discharging this electrical energy into a load, namely the animal. In one embodiment, the intensity of the stimulus is defined by the amount of electrical current applied to the electrical components and the duration at which the current is applied. Accordingly, in such an embodiment, selecting the intensity of the stimulus includes selecting the magnitude of the electrical current applied to the electrical components and selecting the pulse width of the applied current. Along these lines, in one embodiment, the magnitude of the current applied to the components is governed by the selected range of available intensities, and the pulse width of the applied current is governed by the selected one of the plurality of intensities. FIG. 3 illustrates one example of such an embodiment.

FIG. 3 illustrates a more specific embodiment of that illustrated at FIG. 2. More specifically, in the embodiment of FIG. 3, the High Range is defined by a maximum current magnitude, the Medium Range is defined by a midway current magnitude, and the Low Range is defined by a minimum current magnitude. Additionally, Intensity A is defined by a maximum current pulse width, Intensity B is defined by a midway current pulse width, and Intensity C is defined by a minimum current pulse width. The various potential combinations of current magnitude and current pulse width result in various potential voltages. These voltages define the intensity of the stimulus delivered to the animal. Accordingly, when the Low Range is selected, Intensity A is defined as a 184V stimulus, Intensity B is defined as a 128V stimulus, and Intensity C is defined as a 42V stimulus. Likewise, when the Medium Range is selected, Intensity A is defined as a 528V stimulus, Intensity B is defined as a 312V stimulus, and Intensity C is defined as a 226V stimulus. And, when the High Range is selected, Intensity A is defined as a 1720V stimulus, Intensity B is defined as a 1020V stimulus, and Intensity C is defined as a 420V stimulus.

From the foregoing description, those skilled in the art will recognize that an animal training system for delivering a stimulus to an animal offering advantages over the prior art has been provided. More specifically, the intensity of the stimulus is selected from a plurality of intensities, whereby each of the plurality of intensities is within a range of available intensities. The range of available intensities is selected or defined by a user such that the lower limit and the upper limit of the selected range of available intensities defines the lower limit for the minimum intensity and the upper limit for the maximum intensity of the plurality of intensities, respectively. Accordingly, each of the plurality of intensities is defined by the selected range of available intensities. The training system enables a user, or an automated feature, to select one of the plurality of intensities, the selected intensity defining the intensity of the stimulus delivered to the animal. Consequently, the system enables the user to select the range of available intensities such that each of the plurality of intensities is suitable to be delivered to the animal in view of the animal's particular sensitivities to the stimulus.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. An animal training system comprising:
a transmitter device that transmits an activation signal, the activation signal indicating a selected one of a plurality of intensities, the plurality of intensities being within a range of available intensities, the range of available intensities being selected by a user; and
a stimulus delivery device adapted to be carried by an animal, said stimulus delivery device receives the activation signal and delivers to the animal a stimulus having the selected one of the plurality of intensities.

2. The animal training system of claim 1 wherein each of the plurality of intensities is suitable for use in training the animal.

3. The animal training system of claim 1 wherein the user selects the selected one of the plurality of intensities.

4. The animal training system of claim 1 wherein said animal training system selects the selected one of the plurality of intensities based on a detected behavior exhibited by the animal.

5. The animal training system of claim 1 wherein said transmitter device includes transmitter device controls.

6. The animal training system of claim 5 wherein said transmitter device transmits the activation signal in response the user's operation of at least one of the transmitter device controls.

7. The animal training system of claim 1 wherein said transmitter device transmits the activation signal in response to detecting the occurrence of a predetermined event.

8. The animal training system of claim 7 wherein the predetermined event includes a behavior exhibited by the animal.

9. The animal training system of claim 1 wherein the user selects the range of available intensities using said transmitter device.

10. The animal training system of claim 1 wherein the user selects the range of available intensities using said stimulus delivery device.

11. A method for selecting an intensity of a stimulus delivered to an animal, said method comprising the steps of:
selecting a range of available intensities; and
selecting one of a plurality of intensities, each of the plurality of intensities being within the range of available intensities such that each of the plurality of intensities is defined by the selected range of available intensities.

12. The method of claim 11 wherein each of the plurality of intensities is suitable for being delivered to the animal.

13. The method of claim 11 wherein said step of selecting a range of available intensities includes selecting from a plurality of discrete ranges of available intensities.

14. The method of claim 11 wherein said step of selecting a range of available intensities includes defining a lower limit and an upper limit of the range.

15. The method of claim 11 wherein said step of selecting one of a plurality of intensities includes a user manually selecting one of the plurality of intensities.

16. An animal training system comprising:
a transmitter device having at least one user control, a user selects one of a plurality of intensities using the user control, the plurality of intensities being within a range of available intensities selected by the user, each of the plurality of intensities being dependent on the selected range of available intensities and being suitable for use in training an animal, said transmitter device transmits an activation signal in response to the user operating the at least one user control, the activation signal indicating the selected one of the plurality of intensities; and
a stimulus delivery device adapted to be carried by the animal, said stimulus delivery device receives the activation signal and delivers to the animal a stimulus having the selected one of the plurality of intensities.

17. The animal training system of claim 16 wherein the user selects the range of available intensities by selecting from a plurality of discrete ranges of available intensities.

18. The animal training system of claim 16 wherein the user selects the range of available intensities by defining a lower limit and an upper limit of the range.

19. The animal training system of claim 16 wherein the user selects the range of available intensities using said transmitter device.

20. The animal training system of claim 16 wherein the user selects the range of available intensities using said stimulus delivery device.
